(19) United States
(12) Patent Application Publication
(10) Pub. No.: US 2019/0057288 A1
(43) Pub. Date: Feb. 21, 2019

(54) Encoder, robot and printer

(71) Applicant: Seiko Epson Corporation, Tokyo (JP)

(72) Inventors: Daiki TOKUSHIMA, Azumino (JP); Takayuki KONDO, Chino (JP)

(21) Appl. No.: 15/999,328

(22) Filed: Aug. 17, 2018

(30) Foreign Application Priority Data
Aug. 18, 2017 (JP) 2017-158235

(51) Int. Cl. G06K 15/02; B25J 9/04; B25J 9/16; G06K 9/62; B25J 9/12; G06T 7/73

(52) U.S. Cl. CPC G06K 15/1876; B25J 9/042; B25J 9/1684; G06K 9/00536; B25J 9/126; B25J 9/1664; G06T 7/74; G06K 9/6203

(57) ABSTRACT

An encoder includes a base part, a rotation part provided rotatably about a rotation axis relative to the base part, an irregular pattern placed along about the rotation axis in the rotation part, an image pickup device placed in the base part and capturing the pattern, and a determination part that determines a rotation state of the rotation part relative to the base part using an imaging result of the image pickup device.

### BACKGROUND

### 1. Technical Field

The present invention relates to an encoder, robot and printer.

### 2. Related Art

As a kind of encoder, optical rotary encoders are generally known (for example, see Patent Document 1 (JP-A-63-187118)). The rotary encoder detects, in e.g. a robot including a robot arm having a rotatable joint part, rotation states of the rotation angle, rotation position, rotation number, rotation speed etc. of the joint part. The detection results are used for e.g. drive control of the joint part.

For example, the encoder disclosed in Patent Document 1 reads a code plate in which a numerical pattern of gray code or the like and a striped pattern are formed using an image pickup device and detects a position from the read numerical pattern and striped pattern.

However, in the encoder disclosed in Patent Document 1, for realization of higher detection accuracy, a high-definition pattern should be formed in the code plate and extremely high accuracy is required for positioning when the code plate is placed. Accordingly, in the encoder disclosed in Patent Document 1, in practice, there is a problem of difficulty in realization of higher detection accuracy.

### SUMMARY

An advantage of some aspects of the invention is to provide an encoder with higher detection accuracy, and a robot and printer including the encoder.

The invention can be implemented as the following application examples or embodiments.

An encoder of an application example includes a base part, a rotation part provided rotatably about a rotation axis relative to the base part, an irregular pattern placed along about the rotation axis in the rotation part, an image pickup device placed in the base part and capturing the pattern, and a determination part that determines a rotation state of the rotation part relative to the base part using an imaging result of the image pickup device.

According to the encoder, the determination part determines the rotation state of the rotation part relative to the base part using the imaging result of the image pickup device, and thereby, even without a high-definition pattern, the rotation state may be detected with higher accuracy. Further, the pattern is irregular, and thereby, even without high-definition alignment of the pattern with the rotation part, the pattern of the captured image of the image pickup device may be made different for each rotation state and the determination of the rotation state using the imaging result of the image pickup device can be performed. Accordingly, the highly accurate detection of the rotation state can be performed without the need of highly accurate alignment of the pattern with the rotation part.

In the encoder of the application example, it is preferable that the pattern has a plurality of dots based on a dithering method.

With this configuration, the irregular pattern may be easily formed even in a wider range.

In the encoder of the application example, it is preferable that the pattern has dye or pigment.

With this configuration, the irregular pattern may be easily formed using e.g. a printing apparatus. The pattern has an advantage of better discrimination by the image pickup device.

In the encoder of the application example, it is preferable that density of the plurality of dots changes along about the rotation axis.

With this configuration, the amount of calculation for the determination of the irregular pattern may be made smaller (for example, the arithmetic expression used for the dithering method may be simplified). Accordingly, the irregular pattern may be easily formed in a wide area.

In the encoder of the application example, it is preferable that the determination part detects a part of the pattern by performing template matching using a reference image for a captured image of the image pickup device.

With this configuration, even when the pattern (more specifically, the part used as the marks for position identification) is blurred due, to dirt or the like, the positions of the images of the marks within the captured image of the image pickup device may be detected with higher accuracy by template matching. Accordingly, the detection accuracy may be made higher with the lower cost.

In the encoder of the application example, it is preferable that the image pickup device performs imaging including at least two whole marks of a plurality of marks as objects of the template matching.

With this configuration, if it is impossible to correctly read one mark of the two marks captured by the image pickup device due to dirt or the like, it may be possible to read and detect the other mark.

In the encoder of the application example, it is preferable that the determination part sets a search area in a partial area of the captured image and performs the template matching within the search area.

With this configuration, the number of pixels in the search area used for template matching may be made smaller and the calculation time for the template matching may be made shorter. Accordingly, even when the angular velocity of the rotation part is high, high-accuracy detection may be performed. Further, even when distortion or blur of the outer peripheral portion of the captured image of the image pickup device is larger due to aberration of a lens placed between the image pickup device and the mark, the area with less distortion or blur is used as the search area, and thereby, lowering of the detection accuracy may be reduced.

In the encoder of the application example, it is preferable that the determination part can change at least one of a position and a length of the search area in a first direction within the captured image based on information on an angular velocity about the rotation axis of the rotation part.

With this configuration, the search area with a smaller unnecessary part according to the rotation state (angular velocity) of the rotation part may be set, and the number of pixels in the search area used for the template matching may be made smaller.

In the encoder of the application example, it is preferable that the determination part calculates the information on the angular velocity based on previous two or more determination results of the rotation state.

With this configuration, the search area according to the rotation state (angular velocity) of the rotation part may be set relatively easily.

In the encoder of the application example, it is preferable that the determination part can change at least one of the position and the length of the search area in the first direction within the captured image based on information on an angular acceleration about the rotation axis of the rotation part.

With this configuration, the search area with a smaller unnecessary part according to the change (angular acceleration) of the rotation state (angular velocity) of the rotation part may be set.

In the encoder of the application example, it is preferable that the determination part calculates the information on the angular acceleration based on previous three or more determination results of the rotation state.

With this configuration, the search area according to the change (angular acceleration) of the rotation state (angular velocity) of the rotation part may be set relatively easily.

In the encoder of the application example, it is preferable that the determination part can change at least one of a position and a length of the search area in a second direction perpendicular to the first direction within the captured image based on the position of the search area in the first direction within the captured image.

With this configuration, the search area with a smaller unnecessary part according to the rotation state (angular velocity) of the rotation part may be set, and the number of pixels in the search area used for the template matching may be made smaller.

In the encoder of the application example, it is preferable that the determination part can change a posture of the reference image within the captured image based on information on a rotation angle of the rotation part relative to the base part.

With this configuration, even when the change of the posture of the image of the mark is larger within the search area, the accuracy of template matching may be made higher with the reduced amount of calculation of the template matching.

In the encoder of the application example, it is preferable that the determination part determines whether or not the rotation angle of the rotation part relative to the base part is larger than a set angle, and changes the posture of the reference image within the captured image based on a determination result.

With this configuration, the amount of calculation of the template matching may be further reduced with the higher accuracy of the template matching.

A robot of an application example includes a first member, a second member provided rotatably relative to the first member, and the encoder that detects a rotation state of the second member relative to the first member of the application example.

According to the robot, the detection accuracy of the encoder is higher, and high-accuracy operation control of the robot may be performed using the detection result of the encoder.

A printer of an application example includes the encoder of the application example.

According to the printer, the detection accuracy of the encoder is higher, and high-accuracy operation control of the printer may be performed using the detection result of the encoder.

### BRIEF DESCRIPTION OF THE DRAWINGS

The invention will be described with reference to the accompanying drawings, wherein like numbers reference like elements.

FIG. 1 is a side view showing a robot according to the first embodiment of the invention.

FIG. 2 is a sectional view showing an encoder of the robot shown in FIG. 1.

FIG. 3 is a diagram for explanation of patterns of the encoder shown in FIG. 2.

FIG. 4 is a photograph showing enlarged dot patterns by a dithering method.

FIG. 5 is a photograph showing enlarged dot patterns by the dithering method having smaller dot density than that in the case shown in FIG. 4.

FIG. 6 is a diagram for explanation of a modified example of the patterns of the encoder shown in FIG. 2.

FIG. 7 is a sectional view along an optical axis of a telecentric system (imaging system) of the encoder shown in FIG. 2.

FIG. 8 is a diagram for explanation of a captured image of an image pickup device of the encoder shown in FIG. 2.

FIG. 9 is a diagram for explanation of template matching in a search area set within the captured image shown in FIG. 8.

FIG. 10 shows a state in which a correlation value shifts by one pixel from the maximum or minimum in template matching.

FIG. 11 shows a state in which the correlation value is the maximum or minimum in the template matching.

FIG. 12 shows a state in which the correlation value shifts by one pixel from the maximum or minimum toward the opposite side to that shown in FIG. 10 in the template matching.

FIG. 13 is a diagram for explanation of a search area (an area set in consideration of an angular velocity of a rotation part) in an encoder according to the second embodiment of the invention.

FIG. 14 is a diagram for explanation of a search area (an area set in consideration of movement loci of a mark) shown in FIG. 13.

FIG. 15 is a diagram for explanation of a search area (an area set in consideration of an angular velocity and an angular acceleration of a rotation part) in an encoder according to the third embodiment of the invention.

FIG. 16 is a diagram for explanation of a search area (an area set in consideration of a rotation angle of a rotation part) in an encoder according to the fourth embodiment of the invention.

FIG. 17 is a diagram for explanation of a reference image (template) within a search area in an encoder according to the fifth embodiment of the invention.

FIG. 18 shows a state in which a posture of the reference image shown in FIG. 17 has been changed.

FIG. 19 is a sectional view for explanation of an encoder according to the sixth embodiment of the invention.

FIG. 20 is a sectional view for explanation of an encoder according to the seventh embodiment of the invention.

FIG. 21 is a perspective view showing a robot according to the eighth embodiment of the invention.

FIG. 22 shows a schematic configuration of an embodiment of a printer according to the invention.

### DESCRIPTION OF EXEMPLARY EMBODIMENTS

As below, an encoder, robot and printer according to the invention will be explained in detail based on embodiments shown in the accompanying drawings.

### First Embodiment

### Robot

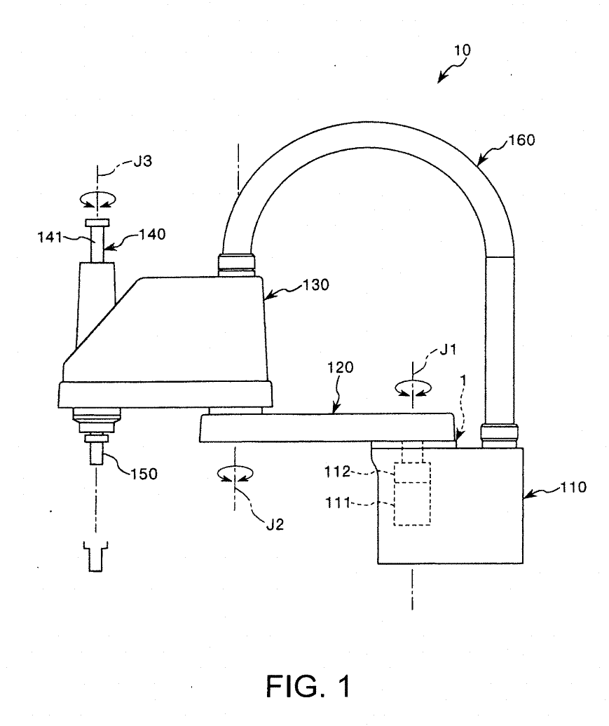

FIG. 1 is a side view showing a robot according to the first embodiment of the invention. Note that, hereinafter, for convenience of explanation, the upside in FIG. 1 is referred to as “upper” and the downside is referred to as “lower”. Further, the base side in FIG. 1 is referred to as “proximal end side” and the opposite side (end effector side) is referred to as “distal end side”. Furthermore, the upward and downward directions in FIG. 1 are referred to as “vertical directions” and the leftward and rightward directions are referred to as “horizontal directions”.

A robot 10 shown in FIG. 1 is the so-called horizontal articulated robot (scalar robot), and is used in e.g. a manufacturing process of manufacturing precision apparatuses etc. and may perform grasping, carrying, etc. of precision apparatuses and components.

As shown in FIG. 1, the robot 10 has a base 110, a first arm 120, a second arm 130, a work head 140, an end effector 150, and a wire routing part 160. As below, the respective parts of the robot 10 will be sequentially and briefly explained.

The base 110 is fixed to e.g. a floor surface (not shown) by bolts or the like. The first arm 120 is coupled to the upper end portion of the base 110. The first arm 120 is rotatable about a first axis J1 along the vertical directions relative to the base 110.

Within the base 110, a first motor 111 that generates drive power for rotating the first arm 120 and a first reducer 112 that reduces the drive power of the first motor 111 are placed. The input shaft of the first reducer 112 is coupled to the rotation shaft of the first motor 111 and the output shaft of the first reducer 112 is coupled to the first arm 120. Accordingly, when the first motor 111 drives and the drive power is transmitted to the first arm 120 via the first reducer 112, the first arm 120 rotates about the first axis J1 within a horizontal plane relative to the base 110.

Further, an encoder 1 as a first encoder that detects the rotation state of the first arm 120 relative to the base 110 is provided on the base 110 and the first arm 120.

The second arm 130 is coupled to the distal end part of the first arm 120. The second arm 130 is rotatable about a second axis J2 along the vertical directions relative to the first arm 120. Within the second arm 130, a second motor that generates drive power for rotating the second arm 130 and a second reducer that reduces the drive power of the second motor are placed (not shown). The drive power of the second motor is transmitted to the first arm 120 via the second reducer, and thereby, the second arm 130 rotates about the second axis J2 within a horizontal plane relative to the first arm 120. Further, a second encoder (not shown) that detects the rotation state of the second arm 130 relative to the first arm 120 is provided in the second motor.

The work head 140 is placed in the distal end part of the second arm 130. The work head 140 has a spline shaft 141 inserted through a spline nut and a ball screw nut (both not shown) coaxially placed in the distal end part of the second arm 130. The spline shaft 141 is rotatable about the axis thereof and movable (up and down) in the upward and downward directions with respect to the second arm 130.

Within the second arm 130, a rotation motor and an elevation motor (not shown) are placed. The drive power of the rotation motor is transmitted to the spline nut by a drive power transmission mechanism (not shown). When the spline nut rotates forward and backward, the spline shaft 141 rotates forward and backward about an axis J3 along the vertical directions. Further, in the rotation motor, a third encoder (not shown) that detects the rotation state of the spline shaft 141 with respect to the second arm 130 is provided.

On the other hand, the drive power of the elevation motor is transmitted to the ball screw nut by a drive power transmission mechanism (not shown). When the ball screw nut rotates forward or backward, the spline shaft 141 moves upward and downward. In the elevation motor, a fourth encoder that detects the amount of movement of the spline shaft 141 with respect to the second arm 130 is provided.

The end effector 150 is coupled to the distal end part (lower end part) of the spline shaft 141. The end effector 150 is not particularly limited, but includes e.g. a tool of grasping an object to be carried and a tool of machining an object to be machined.

A plurality of wires connected to the respective electronic components (e.g. the second motor, rotation motor, elevation motor, first to fourth encoders, etc.) placed within the second arm 130 are routed into the base 110 through within the tubular wire routing part 160 that couples the second arm 130 and the base 110. Further, the plurality of wires are collected within the base 110, and thereby, routed to a control apparatus (not shown) placed outside of the base 110 for integrated control of the robot 10 with the wires connected to the first motor 111 and the encoder 1.

As above, the configuration of the robot 10 is briefly explained. The robot 10 includes the base 110 as a first member, the first arm 120 as a second member rotatably provided relative to the base 110, and the encoder 1 (may be an encoder 1A or 1B) that detects the rotation state of the first arm 120 relative to the base 110. The detection accuracy of the encoder 1 may be made higher as will be described later. Accordingly, high-accuracy operation control of the robot 10 may be performed using the detection result of the encoder 1.

### Encoder

As below, the encoder 1 will be explained in detail. Note that the case where the encoder 1 is incorporated into the robot 10 will be explained as an example.

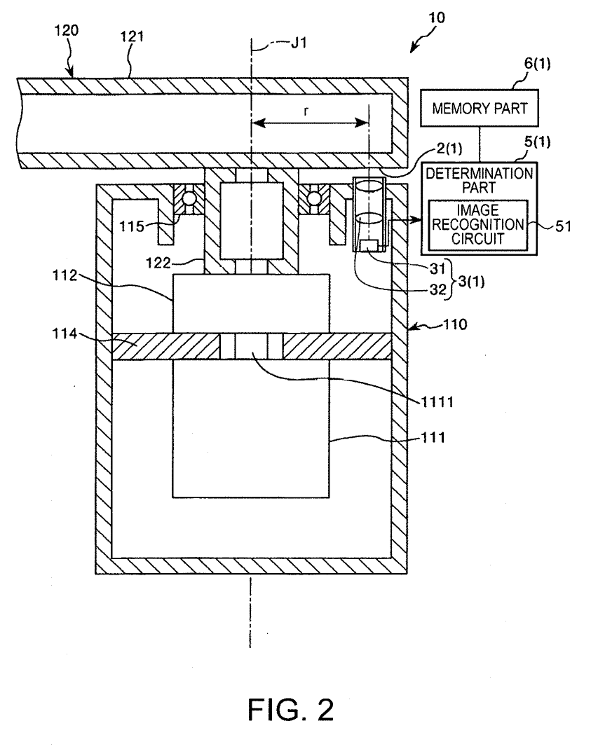

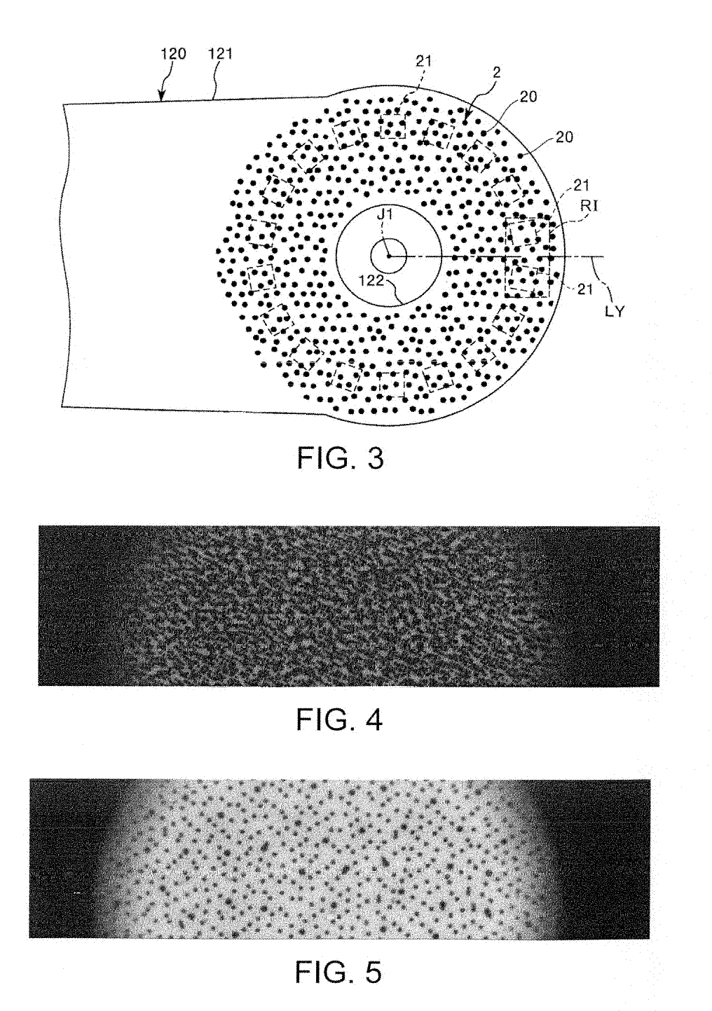

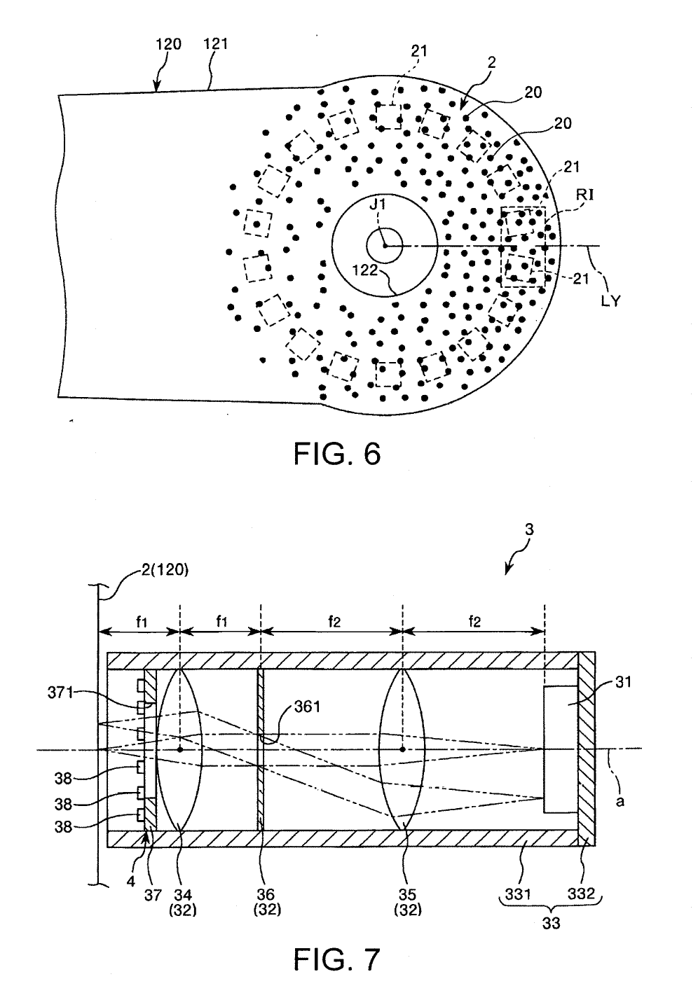

FIG. 2 is a sectional view showing the encoder of the robot shown in FIG. 1. FIG. 3 is a diagram for explanation of patterns of the encoder shown in FIG. 2. FIG. 4 is a photograph showing enlarged dot patterns by a dithering method. FIG. 5 is a photograph showing enlarged dot patterns by the dithering method having smaller dot density than that in the case shown in FIG. 4. FIG. 6 is a diagram for explanation of a modified example of the patterns of the encoder shown in FIG. 2. FIG. 7 is a sectional view along an optical axis of a telecentric system (imaging system) of the encoder shown in FIG. 2. Note that, in the respective drawings except FIGS. 4 and 5, for convenience of explanation, scales of the respective parts are appropriately changed, and the configurations in the drawings do not necessarily coincide with the actual scales and the illustrations of the respective parts are appropriately simplified.

As shown in FIG. 2, the base 110 of the above described robot 10 has a supporting member 114 that supports the first motor 111 and the first reducer 112 and houses the first motor 111 and the first reducer 112. In the base 110, the first arm 120 is provided rotatably about the first axis J1.

The first arm 120 has an arm main body part 121 extending in the horizontal directions and a shaft part 122 projecting downward from the arm main body part 121, and these parts are connected to each other. Further, the shaft part 122 is supported by the base 110 rotatably about the first axis J1 via a bearing 115 and connected to the output shaft of the first reducer 112. The input shaft of the first reducer 112 is connected to a rotation shaft 1111 of the first motor 111.

Here, the base 110 is a structure to which load by the own weight of the base 110 and other mass supported by the base 110 are applied. Similarly, the first arm 120 is a structure to which load by the own weight of the first arm 120 and other mass supported by the first arm 120 are applied. The constituent materials of the base 110 and the first arm 120 are respectively not particularly limited, but may be e.g. metal materials.

In the embodiment, the outer surfaces of the base 110 and the first arm 120 form a part of the outer surface of the robot 10. Note that an exterior member such as a cover or shock absorber may be attached to the outer surfaces of the base 110 and the first arm 120.

In the base 110 and the first arm 120 that relatively rotate, the encoder 1 that detects the rotation state of these is provided.

The encoder 1 has a scale part 2 provided in the first arm 120, a detection part 3 provided in the base 110 and detecting the scale part 2, a determination part 5 that determines the relative rotation state of the base 110 and the first arm 120 based on the detection result of the detection part 3, and a memory part 6 electrically connected to the determination part 5.

The scale part 2 is provided in a portion of the arm main body part 121 opposed to the base 110, i.e., in a portion on the lower surface of the arm main body part 121 surrounding the shaft part 122. As shown in FIG. 3, the scale part 2 has irregular patterns placed in positions different from the first axis J1 along about the first axis J1. Here, the scale part 2 is provided on the surface of the first arm 120. Thereby, it is not necessary to provide a member for providing the scale part 2 separately from the base 110 and the first arm 120. Accordingly, the number of components may be made smaller. Note that the scale part 2 is not limited to that provided directly on the surface of the first arm 120, but may be provided in a sheet-like member stuck to the surface of the first arm 120 or a plate-like member provided to rotate with the first arm 120, for example. That is, the member (rotation part) on which the scale part 2 is provided may be a member that rotates about the first axis J1 relative to the base 110 together with the first arm 120.

As shown in FIG. 3, the scale part 2 (irregular patterns) is formed by irregular arrangement of a plurality of dots 20 (figures) that can be captured by an image pickup device 31. Here, “irregular patterns” refer to patterns in which, when the scale part 2 is rotated over a necessary angle range about the first axis J1 (in the embodiment, an angle range in which the first arm 120 is rotatable relative to the base 110), the same pattern (the pattern impossible for the determination part 5 to identify) appears twice or less in a predetermined area within a captured image G, which will be described later, captured by the image pickup device 31 (e.g. an effective field area RU or search area RS, which will be described later) in a range corresponding to a reference image TA, which will be described later. Accordingly, a plurality of portions of the scale part 2 (corresponding to the reference image TA) may be respectively used as marks 21 for position identification in the circumferential direction of the scale part 2. As described above, the scale part 2 has the plurality of marks 21 different from one another that enable identification of different positions from one another in the circumferential direction of the scale part 2. Note that FIG. 3 shows the case where the plurality of marks 21 are arranged along the circumference around the first axis J1. The positions, sizes, number, etc. of the marks 21 shown in FIG. 3 are examples, but not limited to those.

The scale part 2 (patterns) may be formed using e.g. an inkjet printer (an example of a printing apparatus). In this case, a grayscale image that has been processed using a dithering method is output using an FM screening method as a method of representing light and shade or gradation by adjustment of the density of dots 20, and thereby, the patterns shown in FIG. 4 or 5 are obtained, and these may be used for the scale part 2. FIG. 4 shows an example of the patterns when the plurality of dots 20 are placed relatively densely. FIG. 5 shows an example of the patterns when the plurality of dots 20 are placed relatively scarcely. When the patterns are obtained, the FM screening method may be used singly or a method (e.g. a hybrid screening method) of combining the FM screening method with another method (e.g. an AM screening method as a method of representing light and shade or gradation by adjustment of sizes of dots) may be used.

Note that the color of the dots 20 (figures) of the scale part 2 is not particularly limited, but may be any color. It is preferable that the color is different from the colors of other parts than the dots 20 in the scale part 2 and more preferable that the color is black or dark color. Thereby, the contrast of the captured image of the image pickup device 31 may be made higher and, as a result, detection accuracy may be improved.

Further, the shape of the dots 20 (figures) of the scale part 2 is a circular shape in the drawings, however, may be e.g. an oval shape, rectangular shape, deformed shape, or the like. Furthermore, as long as the pattern of the scale part 2 is an irregular pattern, the pattern is not limited to the dot pattern (figure repetition) like the pattern formed by the above described plurality of dots 20, e.g. a pattern formed by linear lines, a pattern formed by curved lines, a pattern formed by a combination of at least two of dots, linear lines and curved lines, or reversal patterns of these patterns.

As long as the pattern of the scale part 2 is a pattern that can be captured by the image pickup device 31 to be described later, the pattern is not limited to the pattern formed by an ink of dye or pigment using the above described printing apparatus, but may be e.g. a pattern with concavities and convexities, a pattern formed in a natural object, or the like. The pattern with concavities and convexities includes e.g. patterns with concavities and convexities of roughness or unevenness of machined surfaces by etching, cutting, shotblasting, sandblasting, filing, etc., concavities and convexities of fibers on the surfaces of paper, fabrics (non-woven fabric, woven fabric), and concavities and convexities of coating film surfaces. The pattern formed in the natural object includes e.g. wood grain. When a coating film is formed using e.g. a clear coating mixed with black beads, a coating film in which a plurality of black beads are irregularly placed may be obtained, and the plurality of beads of the coating film may be used as irregular patterns for the scale part 2.

The patterns of the scale part 2 are continuously placed about the first axis J1, and thus, when the determination part 5 to be described later generates the reference image (template), the position is less restricted in the rotation direction (circumferential direction) and the degree of freedom is higher. The patterns of the scale part 2 are also placed outside of the effective field area RU in the Y-axis direction of the captured image G, and thus, without high-accuracy alignment of the scale part 2 (patterns) with the first arm 120, the reference image (template) may be generated and the rotation state can be determined.

As shown in FIG. 6, the scale part 2 may have light and shade gradually changing along the circumferential direction. That is, the density of the plurality of dots 20 (placement density) may change along about the first axis J1 (rotation axis). In this case, compared to the case where the light and shade (placement density of the dots 20) are fixed as shown in FIG. 3, the amount of calculation when the irregular patterns used for the scale part 2 are determined may be made smaller (for example, the arithmetic expressions used for the dithering method may be simplified). Accordingly, irregular patterns may be easily formed even in a wider area. Here, it is preferable that the placement density as a ratio occupied by the dots 20 per unit area falls within a range from 10% to 90%. Thereby, the above described advantages can be obtained with higher accuracy of template matching, which will be described later.

The detection part 3 shown in FIG. 2 is provided in the base 110 and has the image pickup device 31 and an optical system 32. The image pickup device 31 captures a part (a part in an imaging area RI shown in FIG. 3) of the scale part 2 (irregular patterns) in the circumferential direction via the optical system 32. Here, the image pickup device 31 is placed on the lower surface of the first arm 120 and set so that the imaging area RI may overlap with a part of the scale part 2.

More specifically, as shown in FIG. 7, the detection part 3 has a casing 33 having a tubular shape with a bottom and an open end, the image pickup device 31, the optical system 32, and an illumination unit 4 housed within the casing 33.

The casing 33 has a tubular member 331 (lens tube) having a tubular shape, and a bottom member 332 on one end of the tubular member 331. The constituent materials of the tubular member 331 and the bottom member 332 are not particularly limited, but include metal materials and resin materials. Further, on the inner circumferential surface of the tubular member 331 and the inner surface of the bottom member 332, treatment for preventing reflection of light, e.g. black coating or the like may be applied.

Within the tubular member 331 of the casing 33, the image pickup device 31, the optical system 32, and the illumination unit 4 are sequentially placed from the bottom member 332 side (image pickup device 31 side) toward the opening side (scale part 2 side).

The image pickup device 31 is fixed to the inner surface of the bottom member 332 of the above described casing 33 (the surface exposed within the tubular member 331) using e.g. an adhesive or the like. The image pickup device 31 is e.g. a CCD (Charge Coupled Devices) or CMOS (Complementary Metal Oxide Semiconductor) and converts and outputs a captured image into electric signals for the respective pixels. To the image pickup device 31, any one of a two-dimensional image pickup device (area image sensor) or one-dimensional image pickup device (line image sensor) can be applied. The one-dimensional image pickup device is desirably placed in a direction in which the arrangement of the pixels is in contact with the swing circle of the arm. In the case of using the two-dimensional image pickup device, a two-dimensional image with the larger amount of information may be acquired and detection accuracy of the marks 21 by template matching to be described later may be easily made higher. As a result, the rotation state of the first arm 120 may be detected with higher accuracy. In the case of using the one-dimensional image pickup device, the image acquisition cycle, the so-called frame rate is higher, and the detection frequency can be made higher and that is advantageous in high-speed operation.

The optical system 32 is an imaging system placed between the scale part 2 and the image pickup device 31. Particularly, the optical system 32 is telecentric on both the object side (scale part 2 side) and the image side (image pickup device 31 side) (bi-telecentric). Here, the object side (scale part 2 side) of the optical system 32 is telecentric, and thereby, even when the distance between the scale part 2 and the image pickup device 31 varies, the change of the imaging magnification to the image pickup device 31 may be reduced and, as a result, lowering of detection accuracy of the encoder 1 may be reduced. Further, the image side (image pickup device 31 side) of the optical system 32 is telecentric, and thereby, even when the distance between the lenses 34, 35 of the optical system 32 to be described later and the image pickup device 31 varies, the change of the imaging magnification to the image pickup device 31 may be reduced. Accordingly, there is an advantage that assembly of the optical system 32 is easier.

The optical system 32 has the lenses 34, 35 and a diaphragm 36. The lens 35, the diaphragm 36, the lens 34, and the illumination unit 4 are sequentially placed from the bottom member 332 side (image pickup device 31 side) toward the opening side (scale part 2 side), and fixed to the inner circumferential surface of the tubular member 331 using e.g. an adhesive or the like.

Here, the lens 34 is set so that the distance between centers of the lens 34 and the diaphragm 36 and the distance between the center of the lens 34 and the scale part 2 may be respectively equal to a focal distance f1 of the lens 34. Further, the lens 35 is set so that the distance between centers of the lens 35 and the diaphragm 36 and the distance between the center of the lens 35 and the imaging surface of the image pickup device 31 may be respectively equal to a focal distance f2 of the lens 35. The diaphragm 36 has an aperture 361 on an optical axis a. Regarding N as the imaging magnification of the optical system 32, a relationship N=f2/f1 is satisfied.

Note that the distance between the center of the lens 34 and the scale part 2 may be different from the distance completely equal to the focal distance f1 within a range of the focal depth of the lens 34. Further, the distance between the center of the lens 35 and the imaging surface of the image pickup device 31 may be different from the distance equal to the focal distance f2 within a range of the focal depth of the lens 35.

In the optical system 32, the principal ray (the ray passing through the center of the diaphragm 36) is parallel to the optical axis a between the scale part 2 and the lens 34. Accordingly, even when the distance between the scale part 2 and the lens 34 changes, the imaging magnification on the image pickup device 31 remains unchanged. In other words, even when the distance between the scale part 2 and the lens 34 changes, the imaging position on the image pickup device 31 remains unchanged.

Note that the optical system 32 is not limited to the telecentric system shown in FIG. 12 as long as the image pickup device 31 can capture the patterns of the scale part 2, but may be e.g. an object side telecentric system or another imaging system than the telecentric system. Or, the optical system 32 may be any one of a unit magnification system, enlargement system, and reduction system.

The illumination unit 4 is placed on the scale part 2 side with respect to the above described optical system 32, and fixed to the inner circumferential surface of the tubular member 331 using e.g. an adhesive or the like. The illumination unit 4 has a board 37 and a plurality of light sources 38 provided on the opposite surface of the board 37 to the lens 34.

The board 37 is e.g. a wiring board and supports the plurality of light sources 38 with electrical connection. In the embodiment, the board 37 has an opening 371 and an annular shape around the optical axis a. Further, the board 37 has a light shielding property and a function of blocking the lights from the light sources 38 entering the lens 34 side.

The plurality of light sources 38 are arranged on the same circumference around the optical axis a along the circumferential direction of the board 37. The respective light sources 38 are e.g. light emitting diodes. Here, the lights output from the light sources 38 preferably have a single wavelength and more preferably have the smaller wavelength in view of reduction of detection accuracy due to chromatic aberration in the lenses 34, 35. Further, the lights output from the light sources 38 are preferably e.g. blue lights because of good sensitivity of the image pickup device 31. The light emitting diodes emitting blue lights are relatively inexpensive. Note that the number, placement, etc. of the light sources 38 are not limited to those shown in the drawing, but it is preferable to illuminate the scale part 2 as evenly as possible for clear imaging in the image pickup device 31. On the light sources 38, an optical component that diffuses the lights may be provided as appropriate.

The determination part 5 shown in FIG. 2 determines the relative rotation state of the base 110 and the first arm 120 based on the detection result of the detection part 3. The rotation state includes e.g. the rotation angle, rotation speed, rotation direction, etc.

Particularly, the determination part 5 has an image recognition circuit 51 for image recognition of the marks 21 by template matching using the reference image (reference image data) with the captured image (captured image data) of the image pickup device 31, and determines the relative rotation state of the base 110 and the first arm 120 using the recognition result of the image recognition circuit 51.

Here, the determination part 5 is adapted to determine the relative rotation state of the base 110 and the first arm 120 (hereinafter, also simply referred to as “the rotation angle of the first arm 120”) in more detail based on the positions of the images of the marks 21 within the captured image of the image pickup device 31. Further, the determination part 5 is adapted to also obtain the rotation speed based on the time intervals at which the marks 21 are detected and determine the rotation direction based on the sequence of the types of the detected marks 21. Then, the determination part 5 outputs signals according to the above described determination result, i.e., signals according to the rotation state of the base 110 and the first arm 120. The signals are input to e.g. a control apparatus (not shown) and used for control of the operation of the robot 10.

Furthermore, the determination part 5 also has a function of generating a reference image (template) by cutting a part of the captured image of the image pickup device 31. The generation of the reference image may be performed prior to the determination of the relative rotation state of the base 110 and the first arm 120 or for each relative rotation state of the base 110 and the first arm 120 as appropriate at a timely basis. Then, the generated reference image is stored in correspondence with each relative rotation state of the base 110 and the first arm 120 in the memory part 6. Then, the determination part 5 performs template matching using the reference image (template) stored in the memory part 6. Note that the template matching and the determination of the rotation state using the template matching will be described later in detail.

The determination part 5 may be formed using e.g. an ASIC (application specific integrated circuit) or FPGA (field-programmable gate array). The determination part 5 is configured as hardware using the ASIC or FPGA, and thereby, the faster processing speed, smaller size, and lower cost of the determination part 5 may be realized. Note that the determination part 5 may include e.g. a processor such as a CPU (Central Processing Unit) and a memory such as a ROM (Read only memory) or RAM (Random Access Memory). In this case, the processor appropriately executes the programs stored in the memory, and thereby, the above described functions may be realized. Further, at least a part of the determination part 5 may be incorporated into the above described control apparatus.

In the memory part 6, the above described reference image (reference image data) is stored for each relative rotation state of the base 110 and the first arm 120 together with information on corresponding coordinates (coordinates of the reference image, which will be described later) within the captured image and information on the rotation angle of the first arm 120 (angle information). As the memory part 6, a nonvolatile memory or volatile memory may be used, however, the nonvolatile memory is preferably used because the status of stored information may be held without power supply and the power may be saved. Note that the memory part 6 may be integrally formed with the above described determination part 5.

As described above, the encoder 1 includes the base 110 as a base part, the first arm 120 as a rotation part provided rotatably about the first axis J1 (rotation axis) relative to the base 110, the scale part 2 as the irregular patterns placed on the first arm 120 along about the first axis J1, the image pickup device 31 placed in the base 110 and capturing the scale part 2, and the determination part 5 that determines the rotation state of the first arm 120 relative to the base 110 using the imaging result (image data of the captured image) of the image pickup device 31.

According to the encoder 1, the determination part determines the rotation state of the first arm 120 relative to the base 110 using the imaging result of the image pickup device 31, and thereby, even without the high-definition scale part 2 (patterns), the rotation state may be detected with higher accuracy. Further, the scale part 2 (patterns) is irregular, and thereby, the patterns of the captured image of the image pickup device 31 may be made different for each rotation state without high-accuracy alignment of the scale part 2 (patterns) with the first arm 120 and the determination of the rotation state using the imaging result of the image pickup device 31 can be performed. Accordingly, the high-accuracy detection of the rotation state can be performed without the need of high-accuracy alignment of the scale part 2 (patterns) with the first arm 120.

Here, it is preferable that the plurality of dots 20 forming the scale part 2 are formed using the dithering method. That is, it is preferable that the scale part 2 (patterns) has the plurality of dots 20 placed based on the dithering method (the plurality of dots 20 based on the dithering method). Thereby, the irregular patterns (scale part 2) may be easily formed even in a wider range.

Further, it is preferable that the scale part 2 (patterns) is drawn using dye or pigment (has dye or pigment). Thereby, the irregular patterns (scale part 2) may be easily formed using e.g. a printing apparatus such as an inkjet printer. The patterns (scale part 2) have an advantage of better discrimination by the image pickup device 31.

Here, as a method of detecting a part of the scale part 2 (patterns) using the imaging result of the image pickup device 31, a method using template matching is preferable. That is, it is preferable that the determination part 5 detects a part of the scale part 2 (patterns) by template matching using the reference image with the captured image of the image pickup device 31. Thereby, even when the scale part 2 (more specifically, the part used as the marks 21 for position identification) is blurred due to dirt or the like, the positions of the images of the marks 21 within the captured image of the image pickup device 31 may be detected with higher accuracy by template matching. Accordingly, the detection accuracy may be made higher with the lower cost.

### Template Matching and Determination of Rotation State Using Template Matching

As below, the template matching and the determination of the rotation state using the template matching in the determination part 5 will be described in detail. Note that the case of determination of the rotation angle as the rotation state will be representatively explained.

### Acquisition of Reference Image

In the encoder 1, the reference image used for template matching is acquired prior to the determination of the rotation state of the first arm 120 relative to the base 110 using the template matching. It is necessary to acquire the reference image only once before the first template matching, however, the acquisition may be subsequently performed as appropriate on a timely basis. In this case, the reference image used for template matching may be updated to a newly acquired reference image.

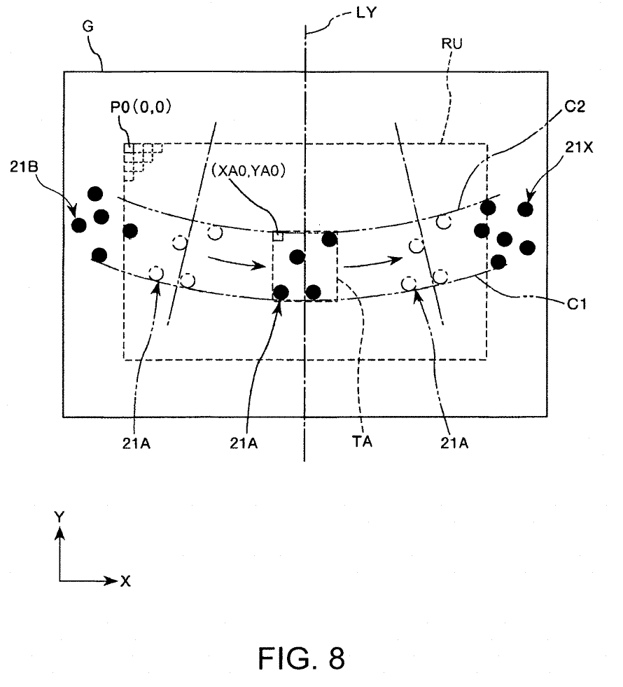

When the reference image is acquired, the first arm 120 is appropriately rotated relative to the base 110 about the first axis J1, and the plurality of marks 21 are captured with respect to each mark 21 by the image pickup device 31. Then, the respective obtained captured images are trimmed, and thereby, the reference images for the respective marks 21 are generated. The generated reference images are stored in the memory part 6 together associated with pixel coordinate information and angle information thereof. As below, this point will be described in detail with reference to FIG. 8.

FIG. 8 is a diagram for explanation of a captured image of the image pickup device of the encoder shown in FIG. 2.

When the first arm 120 rotates about the first axis relative to the base 110, for example, as shown in FIG. 8, a mark image 21A as an image of the mark 21 appearing within the captured image G of the image pickup device 31 moves along arcs C1, C2 within the captured image G. Here, the arc C1 is a locus drawn by the lower end of the mark image 21A in FIG. 8 with the rotation of the first arm 120 relative to the base 110, and the arc C2 is a locus drawn by the upper end of the mark image 21A in FIG. 8 with the rotation of the first arm 120 relative to the base 110. Further, FIG. 8 shows the case where the three marks 21 are included within the imaging area RI shown in FIG. 3, and, in addition to the mark image 21A, a mark image 21B located on one side and a mark image 21X on the other side in the circumferential direction with respect to the mark image 21A are included in correspondence with the three marks in the captured image G shown in FIG. 8.

Here, the captured image G obtained by imaging of the image pickup device 31 has a shape corresponding to the imaging area RI as a rectangular shape having two sides extending in the X-axis direction and two sides extending in the Y-axis direction. The two sides of the captured image G extending in the X-axis direction are placed to be along the arcs C1, C2 as close as possible. Further, the captured image G has a plurality of pixels arranged in a matrix form in the X-axis direction and the Y-axis direction. Here, the position of the pixel is represented by a pixel coordinate system (X,Y) of “X” indicating the position of the pixel in the X-axis direction and “Y” indicating the position of the pixel in the Y-axis direction. The center area of the captured image G except the outer peripheral portion is the effective field area RU, and the pixel on the upper left end of the effective field area RU in the drawing is set as the origin pixel (0,0) of the pixel coordinate system (X,Y).

For example, when the reference image TA corresponding to the mark image 21A is generated, the first arm 120 is appropriately rotated relative to the base 110 so that the mark image 21A may be located in a predetermined position within the effective field area RU (in the drawing, on a center line LY set at the center in the X-axis direction). Here, a rotation angle Δθ0 of the first arm 120 relative to the base 110 when the mark image 21A is located in the predetermined position is acquired in advance by a measurement or the like.

The captured image G is trimmed in a rectangular pixel range as a minimum range required for including the mark image 21A, and thereby, the reference image TA (a template for detection of the mark 21) is obtained. The obtained reference image TA is stored in the memory part 6. In this regard, the reference image TA is stored together associated with angle information on the above described rotation angle θA0 and pixel information on reference pixel coordinates (XA0, YA0) as the pixel coordinates of the reference pixel (in the drawing, the pixel on the upper left end) in the pixel range of the reference image TA. That is, the reference image TA, the angle information, and the pixel coordinate information form a single template set used for template matching.

### Determination of Rotation State Using Template Matching

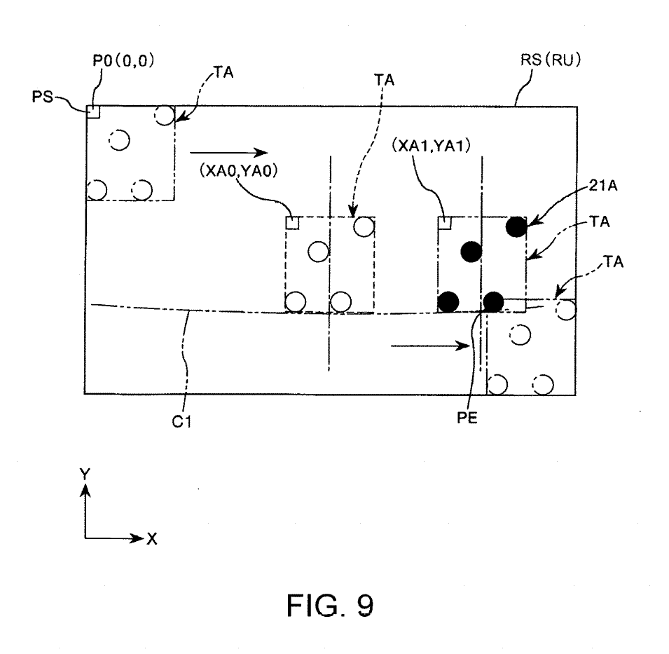

Next, the template matching using the reference image TA generated in the above described manner will be explained with reference to FIGS. 9 to 12.

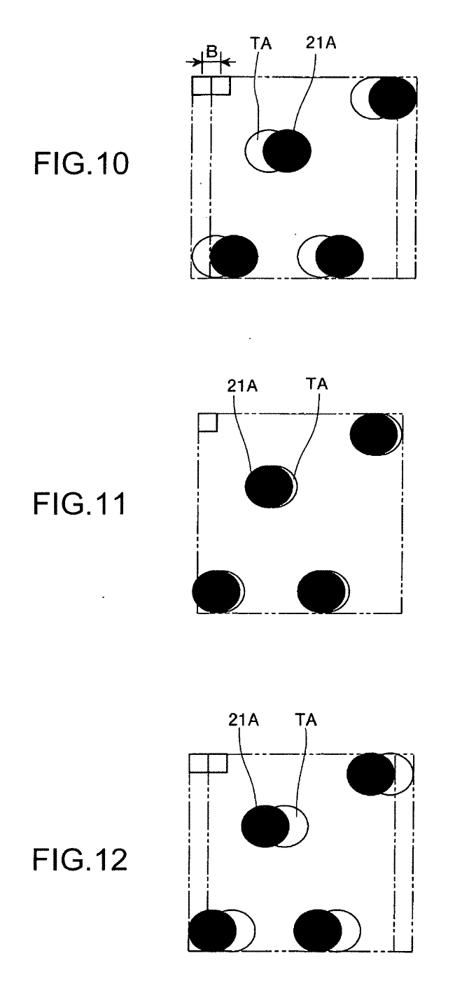

FIG. 9 is a diagram for explanation of template matching in a search area set within the captured image shown in FIG. 8. FIG. 10 shows a state in which a correlation value shifts by one pixel from the maximum or minimum in template matching. FIG. 11 shows a state in which the correlation value is the maximum or minimum in the template matching. FIG. 12 shows a state in which the correlation value shifts by one pixel from the maximum or minimum toward the opposite side to that shown in FIG. 10 in the template matching.

As shown in FIG. 9, when the mark image 21A is present within the effective field area RU, template matching is performed on the image in the effective field area RU using the reference image TA. In the embodiment, with the whole effective field area RU as a search area RS, the reference image TA is overlapped with the search area RS, and correlation values of the overlapping portions of the search area RS and the reference image TA are calculated while the reference image TA is shifted by one pixel at a time with respect to the search area RS. Here, the pixel coordinates of the reference image TA move from start coordinates PS (origin pixel P0) to end coordinates PE by one pixel at a time, and the correlation values of the overlapping portions of the search area RS and the reference image TA are calculated for the respective pixel coordinates of the reference pixel of the reference image TA with respect to the pixels of the whole search area RS. Then, the calculated correlation values are stored in the memory part 6 in association with the pixel coordinates of the reference pixel of the reference image TA as correlation value data of the captured image data and the reference image data.

Then, of the plurality of correlation values for the respective pixel coordinates stored in the memory part 6, the correlation value as the maximum value is selected and pixel coordinates (XA1, YA1) of the reference image TA having the selected correlation value are determined as the pixel coordinates of the mark image 21A. In this manner, the position of the mark image 21A within the captured image G may be detected.

Here, when the pixel coordinates of the mark image 21A are obtained, sub-pixel estimation is preferably used. In the vicinity of the maximum correlation value, as shown in FIGS. 10 to 12, the reference image TA overlaps with the mark image 21A. The state shown in FIG. 11 has a larger correlation value than those in the states shown in FIG. 10, 12 (the states with single pixel shifts from the state shown in FIG. 11), and the correlation value is the maximum. However, when the reference image TA does not completely coincide with the mark image 21A, but overlaps with a deviation as shown in FIG. 11, the state shown in FIG. 11 is determined as the pixel position of the mark image 21A and the deviation is an error. The deviation is a field size B at the maximum. That is, in the case without using the sub-pixel estimation, the field size B is the minimum resolution (accuracy). On the other hand, in the case of using the sub-pixel estimation, the correlation values for the respective field sizes B are fit by a parabola or the like (or isogonal lines) and complemented (approximated) between these correlation values (between pixel pitches). Accordingly, the pixel coordinates of the mark image 21A may be obtained with higher accuracy. Note that, in the above explanation, the case where the pixel coordinates having the maximum correlation value indicate the pixel position of the mark image 21A is explained as an example, however, template matching can be performed so that the pixel coordinates having the minimum correlation value may indicate the pixel position of the mark image 21A.

As described above, the determination part 5 sets the search area RS in the effective field area RU as a partial area of the captured image G and template matching is performed within the search area RS. Thereby, the number of pixels in the search area RS used for template matching is made smaller and the calculation time for the template matching may be made shorter. Accordingly, even when the angular velocity about the first axis J1 of the first arm 120 is fast, high-accuracy detection may be performed. Further, even when distortion or blur of the outer peripheral portion of the captured image G is larger due to aberration of the optical system 32 placed between the image pickup device 31 and the mark 21, the area with less distortion or blur is used as the search area RS, and thereby, lowering of the detection accuracy may be reduced. Note that the generation of the reference image TA and the template matching may be performed using the whole captured image G, and, in this case, correction in consideration of the aberration is preferably performed as appropriate.

In the embodiment, the distance between the imaging area RI and the first axis J1 is sufficiently long, and thus, the arcs C1, C2 may be respectively approximated close to lines within the captured image G. Therefore, it is considered that the movement direction of the mark image 21A coincides with the X-axis direction within the captured image G.

In this regard, the mark image 21A shown in FIG. 9 is located in the position deviated from the reference image TA at the reference pixel coordinates (XA0,YA0) by the number of pixels (XA1−XA0) in the X-axis direction. Therefore, letting the distance between the center of the imaging area RI and the first axis J1 be r and the width of the area corresponding to one pixel of the image pickup device 31 on the imaging area RI in the X-axis direction (the field size per one pixel of the image pickup device 31) be W, the rotation angle θ of the first arm 120 relative to the base 110 may be obtained using the following formula (1).

$$θ = θ A 0 + \frac{( X A 1 - X A 0 ) \times W}{2 r π} \times 360 [ ° ] \qquad ( 1 )$$

In the formula (1), (XA1−XA0)×W corresponds to a distance between the real position corresponding to the reference pixel coordinates (XA0,YA0) of the reference image TA and the real position corresponding to the pixel coordinates (XA1,YA1) of the reference image TA at which the above described correlation value is the maximum. Further, 2rπ corresponds to the length of the locus of the mark 21 when the first arm 120 rotates relative to the base 110 by 360° (the length of the circumference). Note that θA0 is the rotation angle of the first arm 120 relative to the base 110 when the mark image 21A is located in the predetermined position as described above. Further, the rotation angle θ is an angle to which the first arm 120 rotates relative to the base 110 from the reference state (0°).

The above described template matching and calculation of the rotation angle θ are performed on the other marks 21 in the same manner. Here, at an arbitrary rotation angle θ, at least one mark 21 appears without any lack within the effective field area RU and the reference images corresponding to the respective marks are registered so that template matching can be performed. Thereby, production of an angle range in which template matching is impossible may be prevented.

In the above described FIG. 8, at an arbitrary rotation angle θ, the mark 21 and the effective field area RU are formed so that one mark 21 may appear without any lack within the effective field area RU, however, it is preferable that, at an arbitrary rotation angle θ, the mark 21 and the effective field area RU are formed so that a plurality of the marks 21 may appear without any lack within the effective field area RU. In this case, at an arbitrary rotation angle θ, template matching is performed using two or more reference images corresponding to two or more marks 21 adjacent to each other so that template matching can be performed on the plurality of marks 21 appearing within the effective field area RU. In this regard, the two or more reference images may partially overlap with each other.

That is, it is preferable that the image pickup device 31 performs imaging including the entire of at least two marks 21 of the plurality of marks 21 as objects for template matching. Thereby, if it is impossible to correctly read one mark 21 of the two marks 21 captured by the image pickup device 31 due to dirt or the like, it may be possible to read and detect the other mark 21. Accordingly, there is an advantage that the higher detection accuracy may be easily secured.

### Second Embodiment

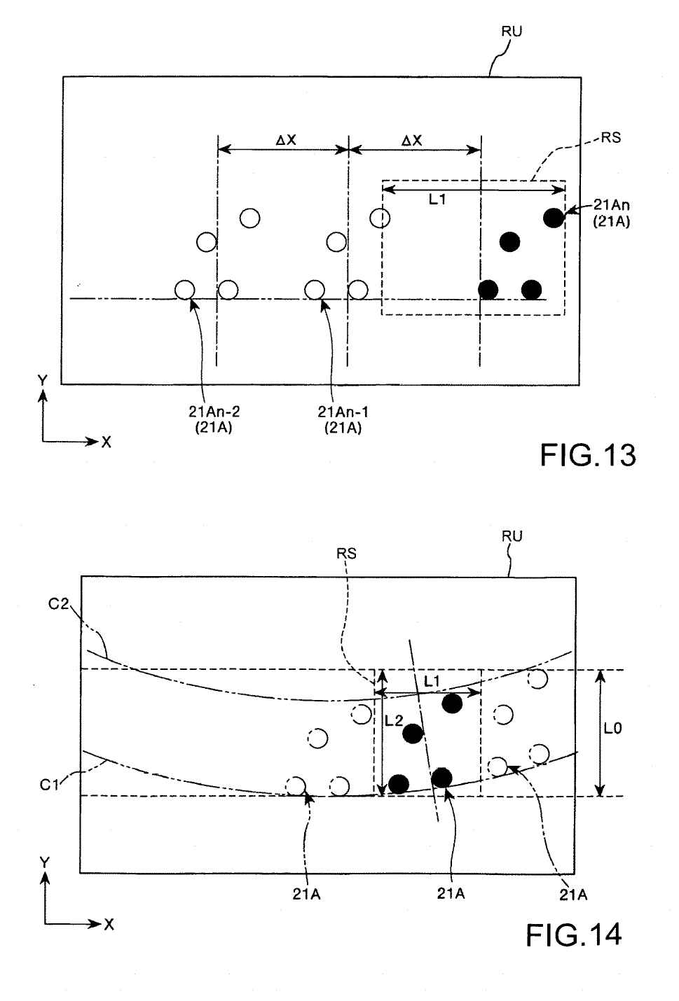

FIG. 13 is a diagram for explanation of a search area (an area set in consideration of an angular velocity, of a rotation part) in an encoder according to the second embodiment of the invention. FIG. 14 is a diagram for explanation of a search area (an area set in consideration of movement loci of a mark).

As below, the second embodiment will be explained with a focus on the differences from the above described embodiment and the explanation of the same items will be omitted.

The embodiment is the same as the above described first embodiment except that the set range of the search area is different.

In the above described first embodiment, the whole effective field area RU is set as the search area RS. That is, in the above described first embodiment, template matching is performed on pixels in the whole effective field area RU and correlation values are calculated. Here, the calculation time required for the determination of the rotation angle θ using template matching is proportional to the number of pixels in the search area RS. Further, the pixel coordinates required for obtaining the rotation angle θ are only the pixel coordinates having the maximum correlation value (in the case of using the sub-pixel estimation, also the adjacent pixel coordinates are required). Therefore, in the first embodiment, a large part of the calculation time is consumed for the unnecessary calculation in some cases.

Accordingly, in the embodiment, the position in which the mark 21 appears in the next imaging is predicted using changes with time of the rotation angle θ in the past, and only the limited pixel area near the position is set as the search area RS. The search area RS is thus set, and thereby, the amount of calculation relating to template matching may be significantly reduced and the calculation time may be significantly shortened.

Specifically, the determination part 5 stores the information of the determination results on the rotation angle θ in correspondence with the respective marks 21 in the memory part 6. Then, the determination part 5 sets (updates) the position and the range of the search area RS using the information on the determination results (rotation angles θ) in the past stored in the memory part 6.

In detail, in the case where the time intervals of the imaging times of the image pickup device 31 are fixed, letting the rotation angle θ determined by imaging of the mark 21 at the last time be θ11, the rotation angle θ determined by imaging of the mark 21 at the second last be θ12, and the rotation angle θ determined by imaging of the mark 21 at the present time be θ14, when the rotation speed (angular velocity) of the first arm 120 relative to the base 110 is fixed, the θ11, θ12, and θ14 are expressed by the following formula (2).

θ14=θ11+(θ11−θ12) (2)

Here, as shown in FIG. 13, the formula (2) represents that the distance between centers between the mark image 21An−1 as the mark image 21A by the imaging at the last time and the mark image 21An as the mark image 21A by the imaging at the present time is equal to the distance between centers ΔX between the mark image 21An−2 as the mark image 21A by the imaging at the second last time and the mark image 21An−1 as the mark image 21A by the imaging at the last time. However, actually, the rotation speed (angular velocity) of the first arm 120 relative to the base 110 generally varies. Letting the amount of variation be Δθ and the real rotation angle θ at the present time be θ13, the θ13 is expressed by the following formula (3).

θ13=θ14+Δθ (3)

Here, if the maximum value of Δθ is known, the range of θ13 may be uniquely determined using the maximum value as Δθ. If the θ14 is determined, a difference (θ14−θA0) from the rotation angle θΔ0 as the angle information of the reference image TA present within the effective field area RU may be determined. Then, the rotation angle θA0 is known, and the pixel range within the effective field area RU in which the mark image 21A matching the reference image TA is present may be predicted based on the difference (θ14−θA0).

The θ13 has a range of the amount of variation Δθ, and thus, a pixel range L1 of the search area RS in the X-axis direction is a range including at least the pixels corresponding to the range of the amount of variation Δθ in addition to the pixel range corresponding to the reference image TA with reference to θ14.

The pixel range of the search area RS in the Y-axis direction may be the whole area of the effective field area RU in the Y-axis direction as described in the first embodiment, however, in the case where the loci (arcs C1, C2) on which the mark image 21A moves within the effective field area RU may be regarded as lines, the pixel range is set to the pixel range of the reference image TA in the Y-axis direction or a range slightly larger than that. Or, in the case where the loci (arcs C1, C2) on which the mark image 21A moves within the effective field area RU are not regarded as lines, as shown in FIG. 14, a pixel range L2 of the search area RS in the Y-axis direction is set as a pixel range L0 (maximum range) of the arcs C1, C2 within the effective field area RU in the Y-axis direction.

The search area RS is set as described above, and thereby, even when the position change of the mark image 21A within the effective field area RU in the Y-axis direction is larger, the appropriate search area RS may be set. Further, the pixel range L2 of the search area RS in the Y-axis direction is set to a part of the effective field area RU in the Y-axis direction, and thereby, the amount of calculation of template matching may be significantly reduced. Here, unlike the normal template matching of two-dimensionally searching images within a wider range, one-dimensional template matching mainly in the X-axis direction within the search area RS may be performed, and thereby, only a half or less of the amount of calculation than that of the normal template matching is necessary.

As described above, in the embodiment, the determination part 5 can change at least one of the position and the length of the search area RS within the captured image G in the X-axis direction as “first direction” based on information on the angular velocity about the first axis J1 (rotation axis) of the first arm 120 (rotation part). Thereby, the search area RS with a smaller unnecessary part according to the rotation state (angular velocity) of the first arm 120 may be set, and the number of pixels of the search area RS used for the template matching may be made smaller.

Here, the determination part 5 calculates the information on the angular velocity of the first arm 120 (rotation part) relative to the base 110 (base part) about the first axis J1 based on the determination results of the rotation angle θ (rotation state) at the previous two or more times. Thereby, the search area RS according to the rotation state (angular velocity) of the first arm 120 (rotation part) may be set relatively easily.

According to the above described second embodiment, the detection accuracy may be made higher with the lower cost.

### Third Embodiment

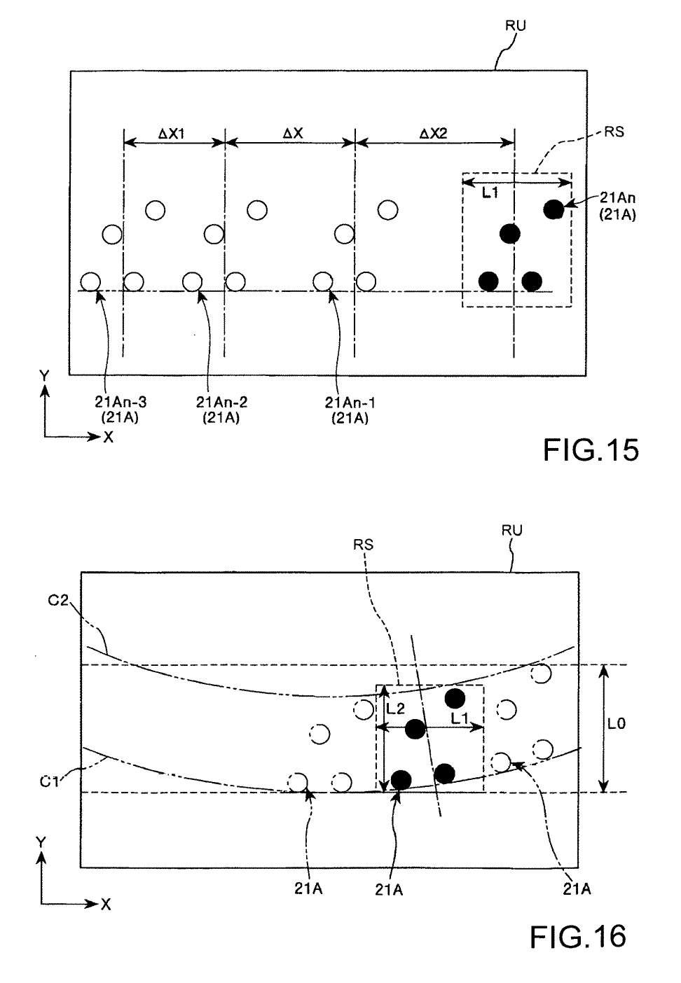

FIG. 15 is a diagram for explanation of a search area (an area set in consideration of an angular velocity and an angular acceleration of a rotation part) in an encoder according to the third embodiment of the invention.

As below, the third embodiment will be explained with a focus on the differences from the above described embodiments and the explanation of the same items will be omitted.

The embodiment is the same as the above described first embodiment except that the set range of the search area is different.

In the above described second embodiment, when the search area RS is set, only the angular velocity of the first arm 120 immediately before predicted from the information on the rotation angles θ (θ11, θ12) at the previous two times, and thus, it is necessary to set the search area RS having a size in consideration of the maximum value of the amount of variation Δθ of the angular velocity.

In the embodiment, when the search area RS is set, information on the rotation angles θ at the previous three or more times is used. Thereby, not only the angular velocity but also the angular acceleration of the first arm 120 may be predicted by a simple calculation. Using the angular acceleration, the Δθ of the above described formula (3) is uniquely determined and the θ13 may be determined to a single value. Note that the determined θ13 is only a predicted value, and it is necessary to obtain a real high-accuracy rotation angle θ by template matching.

For example, as shown in FIG. 15, if a distance between centers ΔX between the mark image 21An−1 as the mark image 21A by the imaging at the last time (n−1 time) and the mark image 21An−2 as the mark image 21A by the imaging at the second last time (n−2 time) is larger than a distance between centers ΔX1 between the mark image 21An−2 as the mark image 21A by the imaging at the second last time (n−2 time) and the mark image 21An−3 as the mark image 21A by the imaging at the third last time (n−3 time), a distance between centers ΔX2 between the mark image 21An−1 by the imaging at the last time and the mark image 21An as the mark image 21A by the imaging at the present time is larger than the distance between centers X.

As described above, in the embodiment, the determination part 5 can change at least one of the position and the length of the search area RS within the captured image in the X-axis direction as “first direction” based on information on the angular acceleration about the first axis J1 (rotation axis) of the first arm 120 (rotation part). Thereby, the search area RS with a smaller unnecessary part according to the change (angular acceleration) of the rotation state (angular velocity) of the first arm 120 may be set.

Here, the determination part 5 calculates the information on the angular acceleration of the first arm 120 (rotation part) relative to the base 110 (base part) about the first axis J1 based on the determination results of the rotation angle θ (rotation state) at the previous three or more times. Thereby, the search area RS according to the change (angular acceleration) of the rotation state (angular velocity) of the first arm 120 may be set relatively easily.

According to the above described third embodiment, the detection accuracy may be made higher with the lower cost.

### Fourth Embodiment

FIG. 16 is a diagram for explanation of a search area (an area set in consideration of a rotation angle of a rotation part) in an encoder according to the fourth embodiment of the invention.

As below, the fourth embodiment will be explained with a focus on the differences from the above described embodiments and the explanation of the same items will be omitted.

The embodiment is the same as the above described first embodiment except that the set range of the search area is different.

The above described arcs C1, C2 can be obtained by a calculation based on a distance r between the center of the imaging area RI and the first axis J1, or, if the distance r is not correctly known, the distance can be known in advance by imaging in the image pickup device 31 while rotating the first arm 120. If the circle C1 or C2 is known in advance, after the above described rotation angle θ13 is obtained, using pixel coordinates corresponding to the rotation angle θ13 on the circle C1 or C2 as predicted pixel coordinates (predicted position) of the mark image 21A, a pixel range larger than the pixel size of the reference image TA by a predetermined range may be set as the search area RS. In this case, as shown in FIG. 16, the pixel range L2 of the search area RS in the Y-axis direction may be minimized (for example, the range may be enlarged by single pixels in the upward and downward directions with respect to the pixel size of the reference image TA). Thereby, the number of pixels of the search area RS may be made even smaller and the amount of calculation may be reduced.

As described above, in the embodiment, the determination part 5 can change at least one of the position and the length of the search area RS within the captured image G in the Y-axis direction (second direction) based on the position of the search area RS within the captured image G in the X-axis direction (first direction). Thereby, the search area RS with a smaller unnecessary part according to the rotation state (angular velocity) of the first arm 120 may be set and the number of pixels of the search area RS used for the template matching may be made smaller.

According to the above described fourth embodiment, the detection accuracy may be made higher with the lower cost.

### Fifth Embodiment

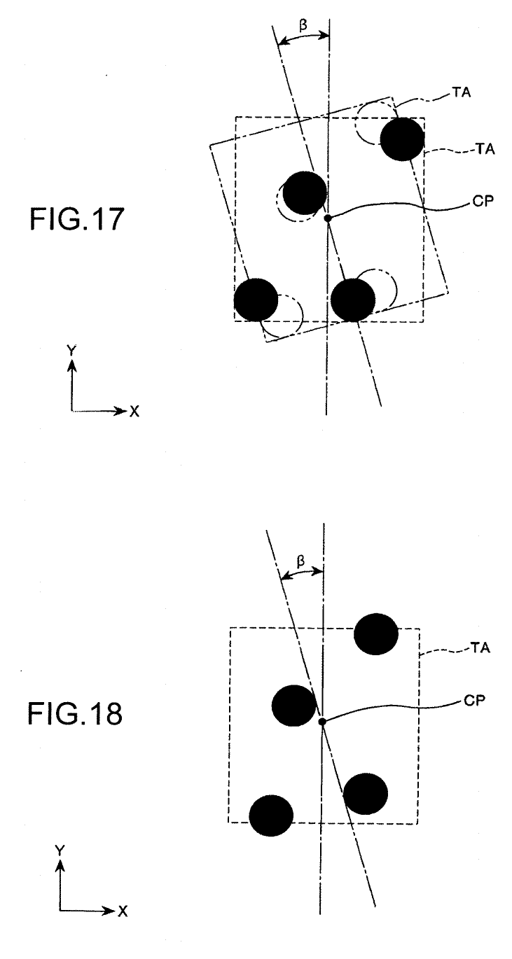

FIG. 17 is a diagram for explanation of a reference image (template) within a search area in an encoder according to the fifth embodiment of the invention. FIG. 18 shows a state in which a posture of the reference image shown in FIG. 17 has been changed.

As below, the fifth embodiment will be explained with a focus on the differences from the above described embodiments and the explanation of the same items will be omitted.

The embodiment is the same as the above described first to fourth embodiments except that an angle correction template matching.

As described above, the image of the mark 21 within the effective field area RU moves along the arcs C1, C2, and thus, the posture of the image tilts relative to the X-axis or Y-axis depending on the position of the image. Further, when the tilt of the image of the mark 21 is larger relative to the reference image TA, the error of the template matching is larger (for example, even when the position coincides, the correlation value is smaller), lowering of the determination accuracy of the rotation angle is caused. As a method of preventing the lowering of the determination accuracy of the rotation angle, there is a conceivable method of obtaining correlation values for respective pixel positions of the reference image TA while shifting the reference image TA by one pixel at a time within the search area RS as described above, then, recalculating the correlation values while slightly changing e.g. the posture (angle) of the reference image TA with respect to several pixel positions having correlation values equal to or more than a predetermined value, and determining the pixel position and the angle at which the correlation value is maximum. However, the amount of calculation is increased by the method.

Accordingly, in the embodiment, with a focus on the tilt of the image of the mark 21 within the effective field area RU changing according to the rotation angle θ, the posture of the reference image TA is changed (hereinafter, also referred to “tilt correction”) based on e.g. the rotation angle θ13 obtained in the same manner as that of the above described second embodiment or third embodiment. If the rotation angle θ13 is known, a tilt angle β of the reference image TA to be corrected is determined and it is only necessary to add a single calculation for tilt correction of the reference image TA. Although the amount of calculation is slightly increased by the added calculation, the determination accuracy of the rotation angle θ may be made higher.

In the above described embodiments, the case where the reference pixel of the reference image TA is set to the pixel on the upper left end is explained, however, in the case where the tilt correction of the reference image TA is performed as in the embodiment, as shown in FIG. 17, it is preferable that the pixel as close as possible to the center CP of the reference image TA is set as the reference pixel, and the reference image TA is rotated by the tilt angle β using the reference pixel as reference (center) and the tilt correction is performed. Thereby, displacement of the reference image TA due to the tilt correction of the reference image TA may be reduced. Note that a correction of enlarging or reducing the reference image TA with reference to the center CP may be performed.

When the tilt correction of the reference image TA is performed, it is preferable to enlarge the pixel range of the reference image TA by adding pixels of a predetermined width to the outer periphery of the reference image TA, then, rotating the pixel range by an angle (tilt angle β) according to the tilt correction, and trimming the rotated pixel range in the size of the original pixel range of the reference image TA. Thereby, as shown in FIG. 18, a pixel defect caused in the reference image TA after the tilt correction may be reduced. Note that, if a pixel defect is caused in the reference image TA, template matching is possible though the detection accuracy is lowered. Or, the tilt correction of the search area RS is performed without the tilt correction of the reference image TA, and thereby, the determination accuracy may be similarly made higher though the amount of calculation is largely increased.

The tilt correction of the reference image TA may be performed with respect to each pixel position of the reference image TA, however, when the tilt of the mark 21 is smaller, the determination accuracy of the rotation angle θ is hardly influenced without the tilt correction of the reference image TA. Accordingly, for example, when the θ13 is predicted in the above described manner, whether or not the predicted θ13 is equal to or smaller than a predetermined angle is determined and, if the predicted rotation angle is larger than the predetermined angle, the tilt correction of the reference image TA is performed and, on the other hand, if the predicted rotation angle is equal to or smaller than the predetermined angle, the tilt correction of the reference image TA is omitted for shortening of the calculation time.

As described above, in the embodiment, the determination part 5 can change the posture of the reference image TA within the captured image G based on the information on the rotation angle θ13 of the first arm 120 (rotation part) relative to the base 110 (base part). Thereby, even when the change of the posture of the image of the mark 21 is larger within the search area RS, the accuracy of template matching may be made higher with the reduced amount of calculation of the template matching.

Further, the determination part 5 determines whether or not the rotation angle θ13 of the first arm 120 (rotation part) relative to the base 110 (base part) is larger than the set angle and changes the posture of the reference image TA within the captured image G based on the determination result. Thereby, the amount of calculation of the template matching may be further reduced with the higher accuracy of the template matching.

### Sixth Embodiment

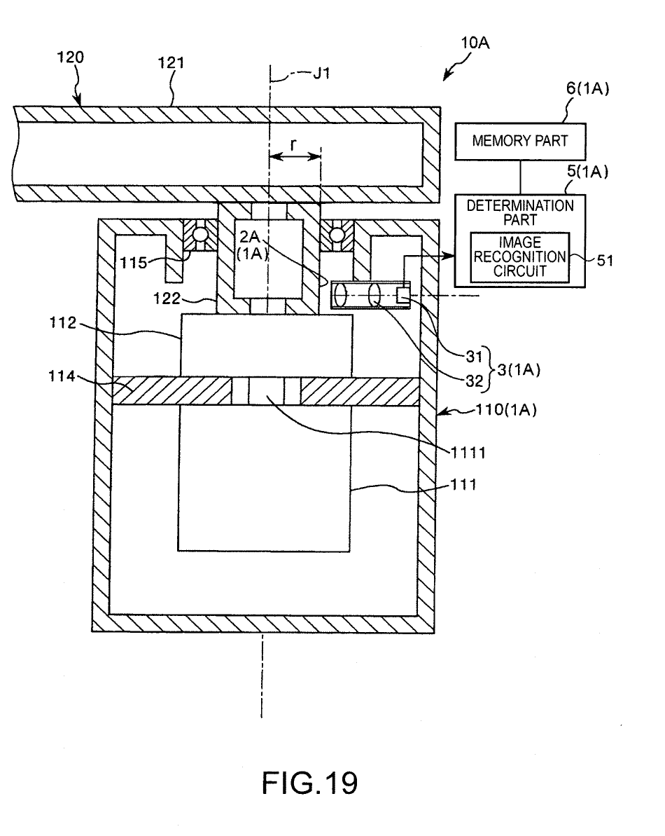

FIG. 19 is a sectional view for explanation of an encoder according to the sixth embodiment of the invention.

As below, the sixth embodiment will be explained with a focus on the differences from the above described embodiments and the explanation of the same items will be omitted.

The embodiment is the same as the above described first embodiment except that the placement position of the scale part (patterns) of the encoder and the configuration relating to the position are different.

A robot 10A shown in FIG. 19 includes an encoder 1A that detects the rotation state of the first arm 120 relative to the base 110. The encoder 1A has a scale part 2A provided on the circumferential surface of an axis portion 122 of the first arm 120, the detection part 3 provided in the base 110 and detecting marks (not shown) of the scale part 2A, the determination part 5 that determines the relative rotation state of the base 110 and the first arm 120 based on the detection result of the detection part 3, and the memory part 6 electrically connected to the determination part 5.

The scale part 2A includes irregular patterns (not shown) like the patterns of the scale part 2 of the above described first embodiment. A plurality of portions different from each other may be respectively used as marks for position identification. Note that the patterns of the scale part 2A may be provided directly on the surface of the axis portion 122 or provided on a cylindrical member attached to the axis portion 122.

In the embodiment, the image pickup device 31 and the optical system 32 of the detection part 3 are placed so that the marks of the scale part 2A may be detected. That is, the direction in which the marks of the scale part 2A and the detection part 3 are arranged is a direction crossing the first axis J1 (in the embodiment a direction orthogonal to the axis). Thereby, the marks of the scale part 2A and the detection part 3 may be made closer to the first axis J1. As a result, reduction in size and weight of the base 110 may be realized.

Further, in the encoder 1A, an imaging area of the image pickup device 31 is set on the outer circumferential surface of the axis portion 122. Then, template matching is performed in the same manner as that of the above described first embodiment. In this regard, the marks of the scale part 2A are provided on the outer circumferential surface of the axis portion 122, and thus, the marks linearly move at fixed postures within the imaging area with the rotation of the axis portion 122. Accordingly, when the template matching is performed, it is not necessary to change the orientation of the reference image (template) according to the postures of the marks within the imaging area, but only necessary to move the reference image in one direction, and thus, there is an advantage that the amount of calculation of template matching may be made smaller.

Note that, since the outer circumferential surface of the axis portion 122 has the cylindrical shape, in the case where the optical system 32 is an enlargement system or reduction system, when the distance from the lens changes, the sizes of the marks of the scale part 2A within the imaging area of the image pickup device 31 change according to the positions within the imaging area. Therefore, in template matching, it is preferable to enlarge or reduce the reference image in view of improvement of the accuracy. If the reference image is not enlarged or reduced, the search area may be set in a small range that is regarded without changes of the sizes of the marks of the scale part 2A or the optical system 32 is designed so that the sizes of the marks of the scale part 2A within the search area of the image pickup device 31 may not be changed, and thereby, high-accuracy template matching can be performed.

According to the above described sixth embodiment, the detection accuracy may be made higher with the lower cost.

### Seventh Embodiment

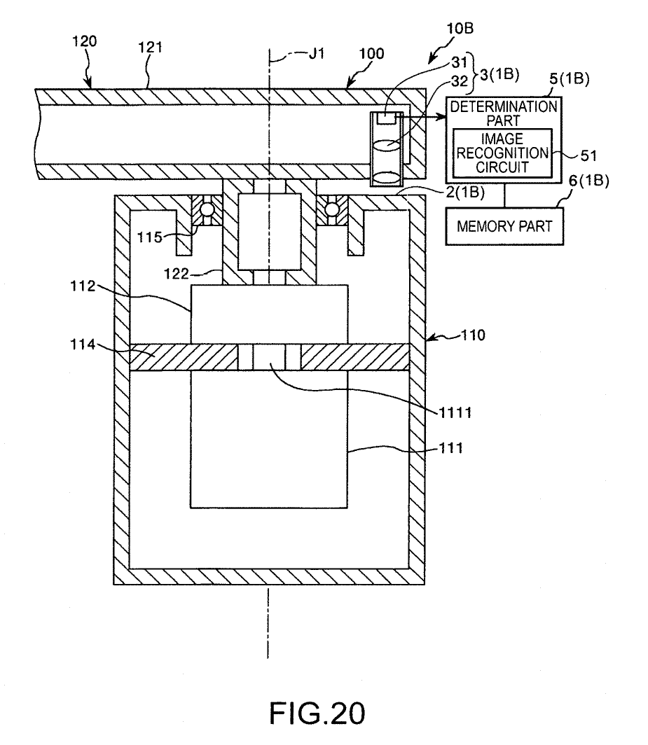

FIG. 20 is a sectional view for explanation of an encoder according to the seventh embodiment of the invention.

As below, the seventh embodiment will be explained with a focus on the differences from the above described embodiments and the explanation of the same items will be omitted.

The embodiment is the same as the above described first embodiment except that placement of the scale part (patterns), image pickup device, and the optical system is different.

A robot 10B shown in FIG. 20 includes an encoder 1B that detects the rotation state of the first arm 120 relative to the base 110.

The encoder 1B has the same basic component elements as the encoder 1 of the above described first embodiment, however, the placement of the scale part 2 and the detection part 3 is reversed to that of the encoder 1. That is, the encoder 1B has the scale part 2 (patterns) provided on the base 110, the detection part 3 provided in the first arm 120 and detecting the scale part 2, the determination part 5 that determines the relative rotation state of the base 110 and the first arm 120 based on the detection result of the detection part 3, and the memory part 6 electrically connected to the determination part 5.

As described above, in the embodiment, the scale part 2 (patterns) is located on the surface of the base 110. Thereby, it is not necessary to separately provide a member for placement of the scale part 2, and the number of components may be reduced and the lower cost may be realized.

According to the above described seventh embodiment, lowering of the detection accuracy of the encoder 1B may be reduced.

### Eighth Embodiment

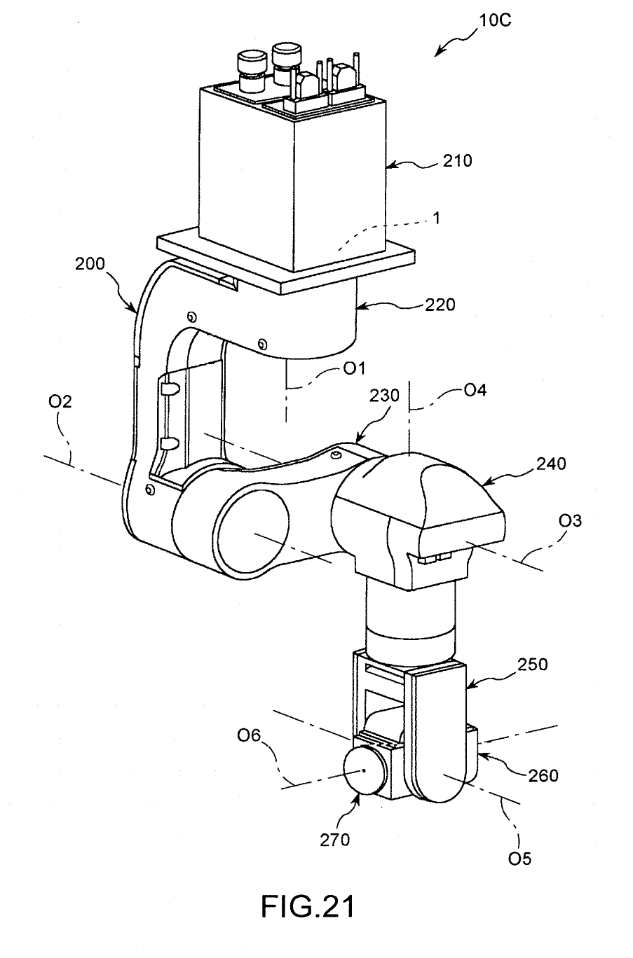

FIG. 21 is a perspective view showing a robot according to the eighth embodiment of the invention. Hereinafter, the side of a base 210 of a robot 100 is referred to as “proximal end side” and the side of an end effector is referred to as “distal end side”.

As below, the eighth embodiment will be explained with a focus on the differences from the above described embodiments and the explanation of the same items will be omitted.

The robot 100 shown in FIG. 21 is a vertical articulated (six-axis) robot. The robot 100 has the base 210 and a robot arm 200, and the robot arm 200 includes a first arm 220, a second arm 230, a third arm 240, a fourth arm 250, a fifth arm 260, and a sixth arm 270 and these arms are sequentially coupled from the proximal end side toward the distal end side. An end effector (not shown) such as a hand that grasps e.g. a precision apparatus, component or the like may be detachably attached to the distal end portion of the sixth arm 270. Further, the robot 10C includes a robot control apparatus (control unit, not shown) of a personal computer (PC) that controls the operations of the respective parts of the robot 10C or the like.

Here, the base 210 is fixed to e.g. a floor, wall, ceiling, or the like. The first arm 220 is rotatable about a first rotation axis O1 relative to the base 210. The second arm 230 is rotatable about a second rotation axis O2 orthogonal to the first rotation axis O1 relative to the first arm 220. The third arm 240 is rotatable about a third rotation axis O3 parallel to the second rotation axis O2 relative to the second arm 230. The fourth arm 250 is rotatable about a fourth rotation axis O4 orthogonal to the third rotation axis O3 relative to the third arm 240. The fifth arm 260 is rotatable about a fifth rotation axis O5 orthogonal to the fourth rotation axis O4 relative to the fourth arm 250. The sixth arm 270 is rotatable about a sixth rotation axis O6 orthogonal to the fifth rotation axis O5 relative to the fifth arm 260. Note that, regarding the first rotation axis O1 to sixth rotation axis O6, “orthogonal” includes the cases where the angle formed by two axes is different from 90° within a range of ±5° and “parallel” includes the cases where one of the two axes is inclined with respect to the other within a range of ±5°.

Further, drive sources (not shown) having motors and reducers are provided in the respective coupling parts (joints) of the base 210 and the first arm 220 to sixth arm 270. Here, the encoder 1 is provided in the drive source that rotates the first arm 220 relative to the base 210. The detection result of the encoder 1 is input to e.g. the robot control apparatus (not shown) and used for drive control of the drive source that rotates the first arm 220 relative to the base 210. Furthermore, encoders (not shown) are provided in the other joint parts and the encoders 1 may be used for the encoders.

As described above, the robot 100 includes the base 210 as a first member, the first arm 220 as a second member provided rotatably relative to the base 210, and the encoder 1 (may be the encoder 1A or 1B, the same applies the following configurations) that detects the rotation state of the first arm 220 relative to the base 210. According to the robot 100, the detection accuracy of the encoder 1 is higher, and high-accuracy operation control of the robot 100 may be performed using the detection result of the encoder 1.

In the above description, the case where the encoder 1 detects the rotation state of the first arm 220 relative to the base 210 is explained, however, the encoder 1 can be provided in the other joint part for detection of the rotation state of the other arm.

### Printer

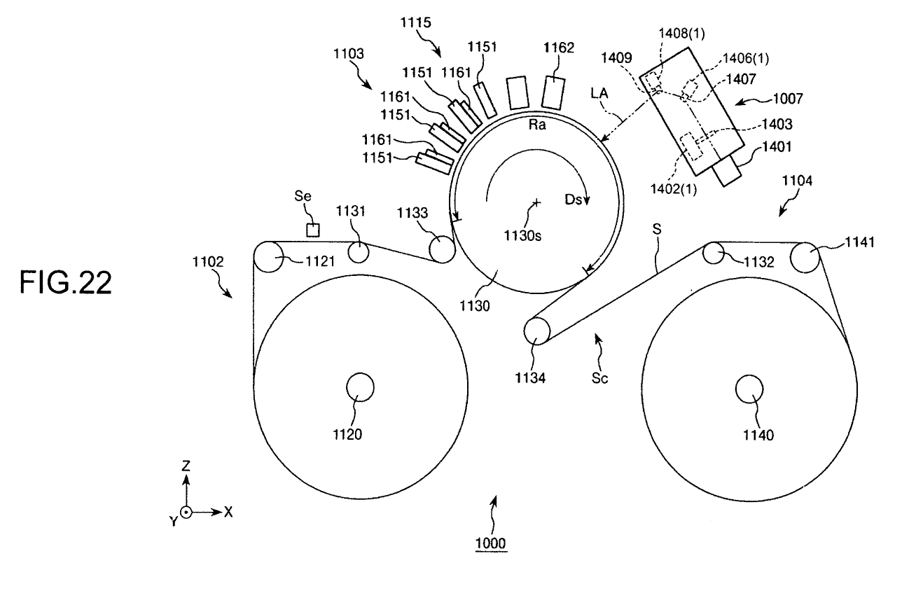

FIG. 22 shows a schematic configuration of an embodiment of a printer according to the invention.

A printer 1000 shown in FIG. 22 is a label printing apparatus including a drum-shaped platen. In the printer 1000, a single sheet S (web) of paper or film with ends wrapped around a feed spindle 1120 and a take-up spindle 1140 in rolls as a recording medium is stretched between the feed spindle 1120 and the take-up spindle 1140, and the sheet S is carried from the feed spindle 1120 to the take-up spindle 1140 along a carrying path Sc in which the sheet is stretched. The printer 1000 is adapted to eject functional liquid to the sheet S carried along the carrying path Sc and record (form) an image on the sheet S.

The printer 1000 includes a feed unit 1102 that feeds the sheet S from the feed spindle 1120, a process unit 1103 that records an image on the sheet S fed from the feed unit 1102, a laser scanner device 1007 that cuts off the sheet S on which the image has been recorded in the process unit 1103, and a take-up unit 1104 that takes up the sheet S around the take-up spindle 1140.

The feed unit 1102 has the feed spindle 1120 around which an end of the sheet S is wrapped, and a driven roller 1121 around which the sheet S drawn from the feed spindle 1120 is wrapped.

The process unit 1103 records an image on the sheet S by appropriate processing using recording heads 1151 or the like provided in a head unit 1115 placed along the outer circumferential surface of a platen drum 1130 with the sheet S fed from the feed unit 1102 and supported by the platen drum 1130 as a supporting part.

The platen drum 1130 is a cylindrical drum rotatably supported by a support mechanism (not shown) around a drum shaft 1130s, and the sheet S carried from the feed unit 1102 to the take-up unit 1104 is wrapped around from the back surface side (the opposite surface to the recording surface). The platen drum 1130 is driven and turned in a carrying direction Ds of the sheet S by a frictional force between the sheet S and the drum, and supports the sheet S from the back surface side over a range Ra in the circumferential direction. Here, in the process unit 1103, driven rollers 1133, 1134 that fold back the sheet S on both sides of the wrapped part around the platen drum 1130 are provided. Further, drive rollers 1121, 1131 and a sensor Se are provided between the feed spindle 1120 and the driven roller 1133, and driven rollers 1132, 1142 are provided between the take-up spindle 1140 and the driven roller 1134.

The process unit 1103 includes the head unit 1115, and the four recording heads corresponding to yellow, cyan, magenta, and black are provided in the head unit 1115. The respective recording heads 1151 are opposed to the surface of the sheet S wrapped around the platen drum 1130 with a slight clearance (platen gap) and eject functional liquids of the corresponding colors from nozzles in an inkjet system. The respective recording heads 1151 eject the functional liquids to the sheet S carried in the carrying direction Ds, and thereby, a color image is formed on the surface of the sheet S.

Here, as the functional liquids, UV (ultraviolet) inks (photocurable inks) to be cured by irradiation with an ultraviolet ray (light) are used. Accordingly, first UV light sources 1161 (light application parts) are provided between the respective plurality of recording heads 1151 for temporary curing and fixation of the UV inks on the sheet S. Further, a second UV light source 1162 as a curing part for complete curing is provided on the downstream side of the carrying direction Ds with respect to the plurality of recording heads 1151 (head units 1115).

The laser scanner device 1007 is provided to partially cut out or divide the sheet S with the image recorded thereon. A laser beam oscillated by a laser oscillator 1401 of the laser scanner device 1007 is applied to the sheet S as an object to be processed via a first lens 1403, a first mirror 1407, and a second mirror 1409 in positions or rotation positions (angles) controlled by drive devices 1402, 1406, 1408 including the encoders 1. As described above, the irradiation position of the laser beam LA applied to the laser S is controlled by the respective drive devices 1402, 1406, 1408, and may be applied to a desired position on the sheet S. The sheet S is fused and cut in the part irradiated with the laser beam LA and partially cut out or divided.

As described above, the printer 1000 includes the encoders 1 (encoders 1A or 1B, the same applies to the following configurations). According to the printer 1000, the detection accuracy of the encoders 1 is higher, and high-accuracy operation control of the printer 1000 may be performed using the detection result of the encoders 1.

As above, the encoder, the robot, and the printer according to the invention are explained based on the illustrated embodiments, however, the invention is not limited to those. The configurations of the respective parts may be replaced by arbitrary configurations having the same functions. Further, other arbitrary configurations may be added to the invention. Furthermore, the configurations of the above described two or more embodiments may be combined.

In the above described embodiments, the case where the base of the robot is “base part (first member)” and the first arm is “rotation part (second member)” is explained as an example, however, one of the two arbitrary members that rotate relative to each other may be “base part” and the other may be “rotation part”. That is, the placement location of the encoder is not limited to the joint part of the base and the first arm, but may be a joint part of arbitrary two arms that rotate relative to each other. The placement location of the encoder is not limited to the joint part of the robot.

In the above described embodiments, only one robot arm is provided, however, the number of robot arms is not limited to that, but may be e.g. two or more. That is, the robot according to the invention may be e.g. a multi-arm robot including a dual-arm robot.

In the above described embodiments, the number of arms of the robot arm is two or six, however, the number of arms is not limited to those, but may be one, three to five, seven, or more.

In the above described embodiments, the placement location of the robot according to the invention is not limited to the floor surface, but may be e.g. a ceiling surface, side wall surface, or the like, or a vehicle such as an AGV (Automatic Guided Vehicle). Further, the robot according to the invention is not limited to a robot fixedly installed in a structure such as a building, but may be e.g. a legged walking (running) robot having led parts.

The encoder according to the invention may be used for not only the above described printer but also various printers such as industrial printers and consumer printers. In the case where the encoder according to the invention is used for a printer, the placement location of the encoder is not limited to those described as above, but the encoder may be used in e.g. a paper-feed mechanism, a movement mechanism of a carriage with an ink head of an inkjet printer mounted thereon, or the like.

The entire disclosure of Japanese Patent Application No. 2017-158235, filed Aug. 18, 2017 is expressly incorporated by reference herein.

What is claimed is:

1. An encoder comprising:
a base part;
a rotation part provided rotatably about a rotation axis relative to the base part;
an irregular pattern placed along about the rotation axis in the rotation part;
an image pickup device placed in the base part and capturing the pattern; and
a determination part that determines a rotation state of the rotation part relative to the base part using an imaging result of the image pickup device.

2. The encoder according to claim 1, wherein the pattern has a plurality of dots based on a dithering method.

3. The encoder according to claim 2, wherein the pattern has dye or pigment.

4. The encoder according to claim 2, wherein density of the plurality of dots changes along about the rotation axis.

5. The encoder according to claim 1, wherein the determination part detects a part of the pattern by performing template matching using a reference image for a captured image of the image pickup device.

6. The encoder according to claim 5, wherein the image pickup device performs imaging including at least two whole marks of a plurality of marks as objects of the template matching.

7. The encoder according to claim 5, wherein the determination part sets a search area in a partial area of the captured image and performs the template matching within the search area.

8. The encoder according to claim wherein the determination part can change at least one of a position and a length of the search area in a first direction within the captured image based on information on an angular velocity about the rotation axis of the rotation part.

9. The encoder according to claim 8, wherein the determination part calculates the information on the angular velocity based on previous two or more determination results of the rotation state.

10. The encoder according to claim 8, wherein the determination part can change at least one of the position and the length of the search area in the first direction within the captured image based on information on an angular acceleration about the rotation axis of the rotation part.

11. The encoder according to claim 10, wherein the determination part calculates the information on the angular acceleration based on previous three or more determination results of the rotation state.

12. The encoder according to claim 8, wherein the determination part can change at least one of a position and a length of the search area in a second direction perpendicular to the first direction within the captured image based on the position of the search area in the first direction within the captured image.

13. The encoder according to claim 5, wherein the determination part can change a posture of the reference image within the captured image based on information on a rotation angle of the rotation part relative to the base part.

14. The encoder according to claim 13, wherein the determination part determines whether or not the rotation angle of the rotation part relative to the base part is larger than a set angle, and changes the posture of the reference image within the captured image based on a determination result.

15. A robot comprising:
a first member;
a second member provided rotatably relative to the first member; and
the encoder that detects a rotation state of the second member relative to the first member according to claim 1.

16. A robot comprising:
a first member;
a second member provided rotatably relative to the first member; and
the encoder that detects a rotation state of the second member relative to the first member according to claim 2.

17. A robot comprising:
a first member;
a second member provided rotatably relative to the first member; and
the encoder that detects a rotation state of the second member relative to the first member according to claim 3.

18. A printer comprising the encoder according to claim 1.

19. A printer comprising the encoder according to claim 2.

20. A printer comprising the encoder according to claim 3.
